(19) United States
(12) Patent Application Publication
(10) Pub. No.: US 2025/0052604 A1
(43) Pub. Date: Feb. 13, 2025

(54) VOLUME MEASUREMENT SYSTEM AND METHOD THE SAME THEREOF

(71) Applicant: Industrial Technology Research Institute, Hsinchu (TW)

(72) Inventors: Cheng-You Chiang, Taoyuan City (TW); Yong-Ren Li, Taichung City (TW); Ta-Cheng Ma, Hsinchu County (TW)

(73) Assignee: Industrial Technology Research Institute, Hsinchu (TW)

(21) Appl. No.: 18/396,614

(22) Filed: Dec. 26, 2023

(30) Foreign Application Priority Data
Aug. 9, 2023 (TW) 112129874

(51) Int. Cl. G01F 17/00; G01B 11/02; G01B 11/04

(52) U.S. Cl. CPC G01F 17/00; G01B 11/024; G01B 11/046

(57) ABSTRACT

A volume measurement method includes: receiving multiple pulse signals when a device under test (DUT) starts passing through a sensing gate; recording multiple X-axis values corresponding to multiple positions of the DUT in response to each pulse signal, and reading the multiple sensing data to calculate a Y-axis value and a Z-axis value corresponding to each X-axis value, wherein the multiple sensing data is obtained by sensing the DUT through the sensing gate; recording a maximum X-axis value corresponding to a final position of the DUT in response to a final pulse signal when the DUT finishes passing through the sensing gate; setting the maximum of the multiple Y-axis values corresponding to the multiple X-axis values as a maximum Y-axis value, and setting the maximum of the multiple Z-axis values corresponding to the multiple X-axis values as a maximum Z-axis value; and calculating a volume of the DUT based on the maximum X-axis value, the maximum Y-axis value and the maximum Z-axis value. The disclosure further includes a volume measurement system.

### CROSS-REFERENCE TO RELATED APPLICATION

This application claims the priority benefit of Taiwan application serial no. 112129874, filed on Aug. 9, 2023. The entirety of the above-mentioned patent application is hereby incorporated by reference herein and made a part of specification.

### TECHNICAL FIELD

The disclosure relates to a measurement system, and in particular relates to a volume measurement system and a method the same thereof

### BACKGROUND

With the continuous development of e-commerce platforms, the volume of goods transported in B2C and C2C models is increasing year by year. For logistics and warehousing businesses, the volume of goods directly affects the overall logistics storage and transportation costs. If the measurement of the volume of goods is not accurate, it will increase the cost of logistics storage and transportation. Therefore, regardless of whether it is warehouse storage or transportation, it is necessary to rely on a more precise volume measurement system to control the storage and transportation status of goods.

Currently, volume measurement systems on the market generally use time of fly (TOF) technology. However, when measuring the volume of goods with metallic or reflective materials, errors may easily occur due to reflection. If shielding technology is adopted, the material of the goods bearing surface must be penetrable for a through-beam sensor. However, high-precision shielding technology cannot be introduced to the high-performance automated conveyor belt.

In the era of rapid development of e-commerce platforms, where the daily volume of goods transported is measured in tens of thousands, automated equipment is often paired with conveyor belts to enhance work efficiency. How to take into account both the high efficiency of automated conveyance and the high precision of volume measurement of goods is an urgent problem that needs to be solved.

### SUMMARY

A volume measurement system, which includes a sensing gate, a pedometer, and a processor, is provided in the disclosure. The sensing gate is configured to sense a device under test to obtain multiple sensing data. The pedometer is configured to generate multiple pulse signals. The processor is coupled to the sensing gate and the pedometer, and is configured to: receive the multiple pulse signals when the device under test starts passing through the sensing gate; record multiple X-axis values corresponding to multiple positions of the device under test in response to each of the pulse signals, and read the multiple sensing data to calculate a Y-axis value and a Z-axis value corresponding to each of the X-axis values; record a maximum X-axis value corresponding to a final position of the device under test in response to a final pulse signal among the multiple pulse signals when the device under test finishes passing through the sensing gate; set a maximum of the multiple Y-axis values corresponding to the multiple X-axis values as a maximum Y-axis value, and set a maximum of the multiple Z-axis values corresponding to the multiple X-axis values as a maximum Z-axis value; and calculate a volume of the device under test based on the maximum X-axis value, the maximum Y-axis value and the maximum Z-axis value.

A volume measurement method is further provided in the disclosure, including: obtaining multiple sensing data by sensing a device under test through a sensing gate; receiving multiple pulse signals generated by a pedometer when the device under test starts passing through the sensing gate; recording multiple X-axis values corresponding to multiple positions of the device under test in response to each of the pulse signals, and reading the multiple sensing data to calculate a Y-axis value and a Z-axis value corresponding to each of the X-axis values; recording a maximum X-axis value corresponding to a final position of the device under test in response to a final pulse signal among the multiple pulse signals when the device under test finishes passing through the sensing gate; set a maximum of the multiple Y-axis values corresponding to the multiple X-axis values as a maximum Y-axis value, and set a maximum of the multiple Z-axis values corresponding to the multiple X-axis values as a maximum Z-axis value; and calculate a volume of the device under test based on the maximum X-axis value, the maximum Y-axis value and the maximum Z-axis value.

Based on the above, the volume measurement system and the method the same thereof provided by the disclosure may determine that there is an object at the sensing position when the sensing signal is blocked. On one hand, a feedback type sensor with a ranging function is disposed in the Z-axis direction to sense whether there is a feedback signal from the object, thereby obtaining the height value of the object. On the other hand, a through-beam type sensor is disposed in the Y-axis direction to sense whether the information is shielded by the object, thereby obtaining the width value of the object. Furthermore, the volume of an object may be calculated by determining the maximum length of the object through a pedometer, and by searching for the maximum height value and maximum width value of the object from the height value and width value of the object at each position. Therefore, the disclosure may overcome common issues in the volume measurement system and the method the same thereof using TOF technology, which are often affected by metals and reflective objects. It takes into account both the high efficiency of automated conveyance and the high precision of volume measurement of goods.

### BRIEF DESCRIPTION OF THE DRAWINGS

FIG. 1 is a schematic diagram of a volume measurement system according to an embodiment of the disclosure.

FIG. 2 is a schematic diagram of a sensing gate of a volume measurement system according to an embodiment of the disclosure.

FIG. 3 is a schematic diagram illustrating a through-beam type sensor of a sensing gate according to an embodiment of the disclosure.

FIG. 4 is a schematic diagram illustrating calculation of the Y-axis value corresponding to each X-axis value according to an embodiment of the disclosure.

FIG. 5 is a schematic diagram illustrating a feedback type sensor of a sensing gate according to an embodiment of the disclosure.

FIG. 6 is a schematic diagram illustrating calculation of the Z-axis value corresponding to each X-axis value according to an embodiment of the disclosure.

FIG. 7 is a schematic diagram illustrating the synchronous operation of the pedometer axle and the conveyor platform according to an embodiment of the disclosure.

FIG. 8 is a schematic diagram of establishing two-dimensional point cloud data and point cloud diagram in a volume measurement system according to an embodiment of the disclosure.

FIG. 9 is a flowchart of a volume measurement method according to an embodiment of the disclosure.

### DETAILED DESCRIPTION OF DISCLOSED EMBODIMENTS

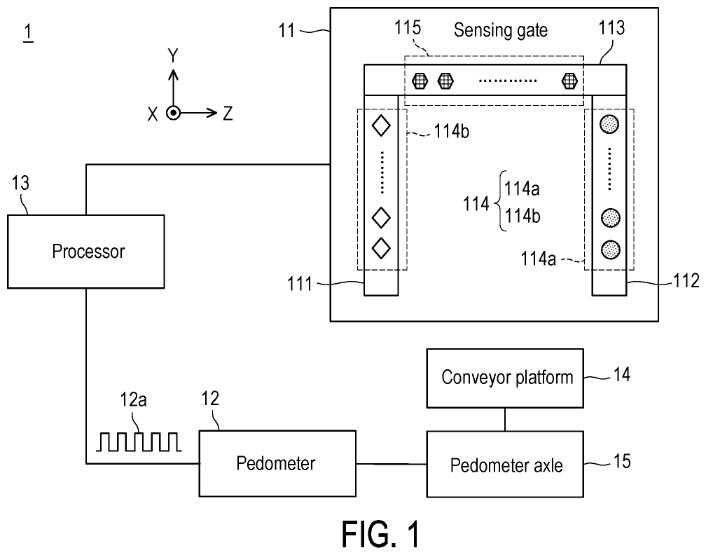

FIG. 1 is a schematic diagram of a volume measurement system 1 according to an embodiment of the disclosure. Referring to FIG. 1, the volume measurement system 1 includes a sensing gate 11, a pedometer 12, a processor 13, and a conveyor platform 14.

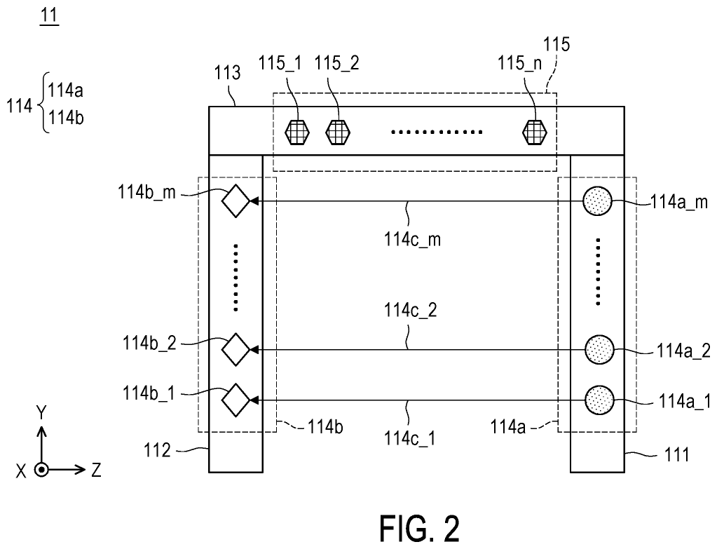

FIG. 2 is a schematic diagram of a sensing gate 11 of a volume measurement system 1 according to an embodiment of the disclosure. Please refer to FIG. 1 and FIG. 2 at the same time, the sensing gate 11 is configured to sense a device under test to obtain multiple sensing data. Architecturally speaking, the sensing gate 11 includes a first side bracket 111, a second side bracket 112 and an upper bracket 113. The first side bracket 111 and the second side bracket 112 are spaced apart approximately parallel to the Y-axis and parallel to each other. The upper bracket 113, parallel to the Z-axis, spans across and connects the top ends of the first side bracket 111 and the second side bracket 112. The sensing gate 11 further includes m sets of through-beam type sensors 114 and n feedback type sensors 115. The m sets of through-beam type sensors 114 are disposed on the first side bracket 111 and the second side bracket 112. The n feedback type sensors 115 are disposed on the upper bracket 113.

The m sets of through-beam type sensors 114 includes m transmitters 114a and m receivers 114b. Specifically, each set of through-beam type sensors 114 includes corresponding transmitters 114a_1 to 114a_m and receivers 114b_1 to 114b_m. The m transmitters 114a_1 to 114a_m are arranged on the first side bracket 111 for transmitting through-beam type sensing signals 114c_1 to 114c_m one by one. Each of the transmitters 114a_1 to 114a_m is separated by a first separation distance. The m receivers 114b_1 to 114b_m are arranged on the second side bracket 112 and are aligned in sequence with each of the transmitters 114a_1 to 114a_m for receiving each through-beam type sensing signal 114c_1 to 114c_m transmitted by each transmitter 114a_1 to 114a_m. Each of the receivers 114b_1 to 114b_m is separated by a first separation distance. In other words, under the condition that there is no object blocking between the transmitters 114a_1 to 114a_m and the receivers 114b_1 to 114b_m in each set of through-beam type sensors 114, the through-beam type sensing signals 114c_1 to 114c_m emitted by the transmitters 114a_1 to 114a_m may be received by the aligned receivers 114b_1 to 114b_m. The through-beam type sensor 114 is, for example, a through-beam type infrared sensor or other similar device, which is not limited by the disclosure.

The n feedback type sensors 115 are arranged on the upper bracket 113. Each of the feedback type sensors 115_1 to 115_n is configured to emit electromagnetic signals, and to receive the reflected signals that are reflected by an object of the electromagnetic signals it has emitted itself. Each of the feedback type sensors 115_1 to 115_n is separated by a second separation distance. The feedback type sensor 115 is, for example, a photoelectric sensor or other similar device, which is not limited by the disclosure.

Referring to FIG. 1 again, the pedometer 12 is configured to generate multiple pulse signals. The pedometer 12 is, for example, a pulse wave generator, a pulse generator, a signal pulse wave generator, a programmable pulse generator or other similar devices, and the disclosure is not limited thereto.

The processor 13 is coupled to the sensing gate 11 and the pedometer 12. The processor 13 is, for example, a central processing unit (CPU), a physical processing unit (PPU), a programmable microprocessor, an embedded control chip, digital signal processor (DSP), an application specific integrated circuit (ASIC), or other similar devices.

The conveyor platform 14 is disposed between the first side bracket 111 and the second side bracket 112 and below the upper bracket 113 to drive the device under test to pass through the sensing gate 11 parallel to the X-axis. After the electromagnetic signal emitted by the feedback type sensor 115 disposed on the upper bracket 111 of the sensing gate 11 contacts the conveyor platform 14, the feedback type sensor 115 may receive the reflected signal. On the other hand, when the conveyor platform 14 drives the device under test to pass through the sensing gate 11 parallel to the X-axis, in addition to the fact that the electromagnetic signal emitted by the feedback type sensor 115 disposed on the upper bracket 113 of the sensing gate 11 is reflected back to the feedback type sensor 115 via the device under test, the through-beam type sensing signal emitted by at least one transmitter 114a disposed on the first side bracket 111 of the sensing gate 11 is blocked by the device under test, causing the aligned receiver 114b to be unable to receive the through-beam type sensing signal. The conveyor platform may be a conveyor belt device.

Next, the operation of measuring the volume of the device under test through the processor 13 in the volume measurement system 1 of the disclosure is further introduced.

First, the conveyor platform 14 drives the device under test to pass through the sensing gate 11 along a direction parallel to the X-axis. When the device under test starts passing through the sensing gate 11, the processor 13 receives multiple pulse signals 12a generated by the pedometer 12 in sequence. In response to each pulse signal 12a, the processor 13 records multiple X-axis values corresponding to multiple positions of the device under test. The multiple positions of the device under test refer to the multiple positions of the device under test in the physical space during the process of being driven by the conveyor platform 14 to pass through the sensing gate 11.

Each time the processor 13 receives a pulse signal, it synchronously records the X-axis value corresponding to the position of the device under test in the physical space. At the same time, the through-beam type sensor 114 and the feedback type sensor 115 of the sensing gate 11 sense the device under test when the object is in each position to obtain corresponding sensing data.

When the processor 13 records each X-axis value corresponding to each position of the device under test when passing through the sensing gate 11, the sensing data obtained after the sensing gate 11 senses the device under test is read to calculate the Y-axis value and Z-axis value corresponding to each X-axis value. Each X-axis value corresponds to the position of the device under test, and the Y-axis value corresponding to the X-axis value is the height of the device under test sensed by the sensing gate 11 when it is at the position corresponding to the X-axis value. The Z-axis value corresponding to the X-axis value is the width of the device under test sensed by the sensing gate 11 when it is at the position corresponding to the X-axis value.

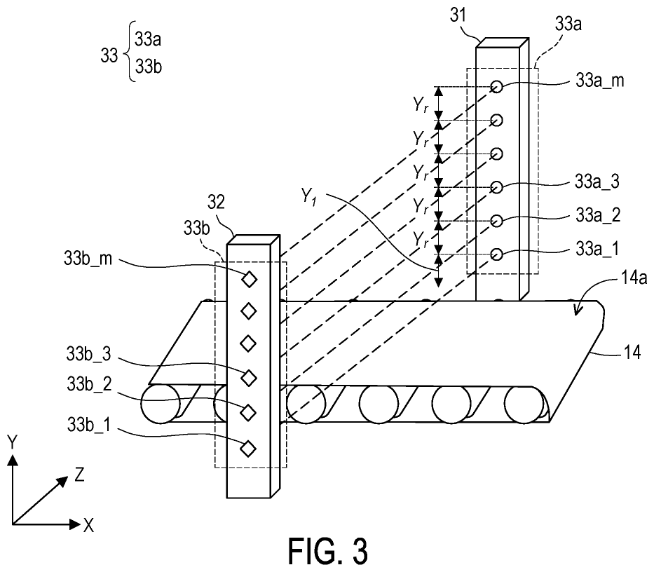

Next, the part where the processor 13 calculates the Y-axis value corresponding to each X-axis value (i.e., the height of the device under test sensed by the sensing gate 11 at each position) is described. FIG. 3 is a schematic diagram illustrating a through-beam type sensor 33 of a sensing gate 11 according to an embodiment of the disclosure. Referring to FIG. 3, the m sets of through-beam type sensors 33 have m transmitters 33a, all of which are disposed on the first side bracket 31. The first transmitter 33a_1 is closest to the horizontal plane 14a of the conveyor platform 14 and is located at the first height Y₁ above the horizontal plane 14a of the conveyor platform 14; the remaining transmitters 33a_2 to 33a_m are arranged vertically in an ascending sequence on the first side bracket 31, starting from a position vertically above a first separation distance Yᵣ from the first transmitter 33a_1, in a direction away from the horizontal plane 14a of the conveyor platform 14.

The m sets of through-beam type sensors 33 also has m receivers 33b_1 to 33b_m, all of which are disposed on the second side bracket 32. Each of the receivers 33b_1 to 33b_m respectively corresponds to each of the transmitters 33a_1 to 33a_m. The first side bracket 31 and the second side bracket 32 are located on two sides of the conveyor platform.

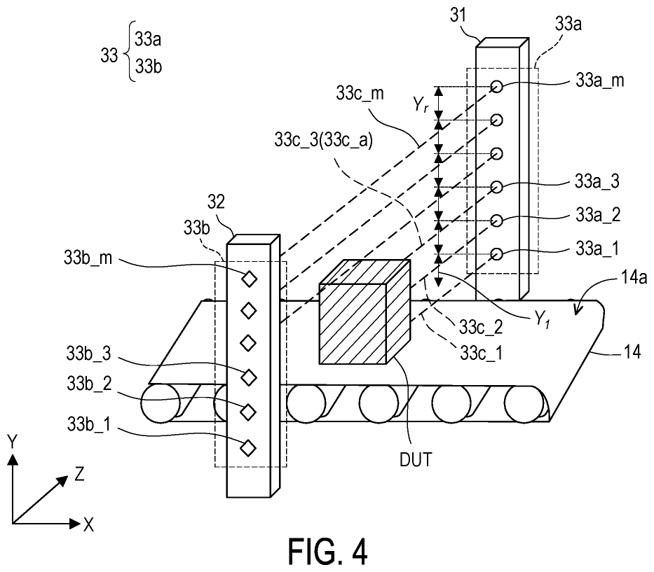

FIG. 4 is a schematic diagram illustrating calculation of the Y-axis value corresponding to each X-axis value according to an embodiment of the disclosure. Referring to FIG. 4, when the device under test DUT is passing through the sensing gate 11, the through-beam type sensing signals (e.g., 33c_1 to 33c_3) emitted by a part of the transmitters (e.g., 33a_1 to 33a_3) of the through-beam type sensors 33 on the sensing gate 11 are blocked by the device under test DUT, causing the aligned receivers (e.g., 33b_1˜33b_3) to be unable to receive the through-beam type sensing signal.

T Therefore, during the process of the device under test DUT passing through the sensing gate 11, when the device under test DUT is located at each position, the processor 13 cannot receive part of the through-beam type sensing signals 33c_1˜33c_m that are blocked and calculates the quantity a of the corresponding part of the through-beam type sensors 33. The Y-axis value corresponding to each X-axis value is calculated according to the quantity a of the part of the through-beam type sensors 33.

The processor 13 calculates the Y-axis value corresponding to each X-axis value according to formula (1):

$${Y}_{i} = {Y}_{1} + ( a - 1 ) \times {Y}_{r} , a = 1 ∼ m ; \qquad ( 1 )$$

Wherein, Yᵢ is the Y-axis value corresponding to the X-axis value when the device under test DUT is located at the i^{th} position, Y₁ is the first height, a is the quantity of the part of the through-beam type sensors blocked by the device under test DUT, Yᵣ is the first separation distance, and m is the total quantity of transmitters 43a_1 to 43a_m.

For example, as shown in FIG. 4, assuming that the device under test DUT is located at the second position, the through-beam type sensing signals 33c_1 to 33c_3 emitted by the transmitters 33a_1 to 33a_3 are blocked by the device under test DUT, causing the aligned receivers 33b_1 to 33b_3 to be unable to receive the through-beam type sensing signals 33c_1 to 33c_3. Therefore, when the device under test DUT is located at the second position, the Y-axis value sensed by the sensing gate 11 is Y₂=Y₁+(4−1)×Y₁=Y₁+3Yᵣ, Y₁+3Yᵣ is the height sensed by the sensing gate 11 when the device under test DUT is located at the second position.

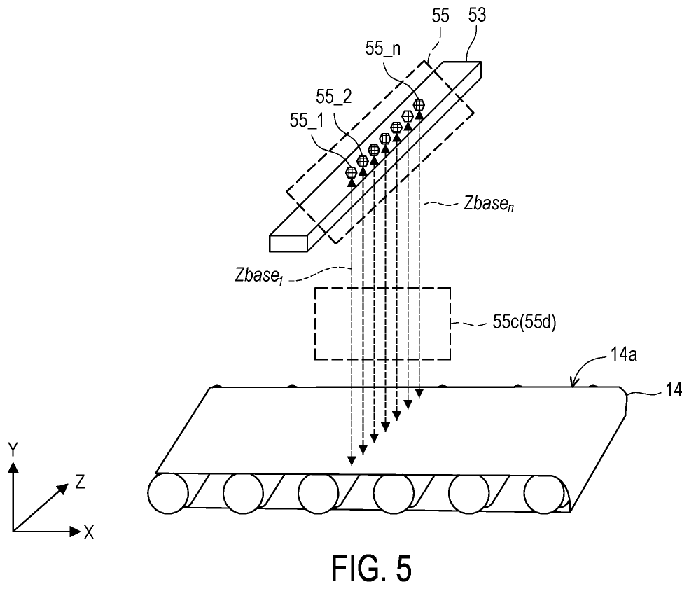

Next, the part where the processor 13 calculates the Z-axis value corresponding to each X-axis value (i.e., the width of the device under test sensed by the sensing gate 11 at each position) is described. FIG. 5 is a schematic diagram illustrating a feedback type sensor 55 of a sensing gate 11 according to an embodiment of the disclosure. Referring to FIG. 5, the feedback type sensors 55_1 to 55_n are all disposed on the upper bracket 53. Before measuring the volume of the device under test, the distance between the feedback type sensor 55_1 to 55_n and the horizontal plane 14a of the conveyor platform 14 needs be measured firstly through each feedback type sensor 55_1 to 55_n, and this distance is set as the sensing reference value Zbase₁ to Zbaseₙ.

Specifically, when the conveyor platform 14 is stationary, each feedback type sensor 55_1 to 55_n of the sensing gate 11 emits an electromagnetic signal 55c. The electromagnetic signal forms a reflected signal 55d after contacting the horizontal surface 14a of the conveyor platform 14, n feedback type sensors 55_1 to 55_n all receive the reflected signal 55d to obtain the sensing reference values Zbase₁ to Zbaseₙ of each feedback sensor 55_1 to 55_n. That is, the feedback type sensor 55_1 obtains the sensing reference value Zbase₁, the feedback type sensor 55_n obtains the sensing reference value Zbaseₙ. After obtaining the sensing reference values Zbase₁ to Zbaseₙ of each feedback type sensor 55_1 to 55_n, the height of the device under test on the conveyor platform 14 may be measured.

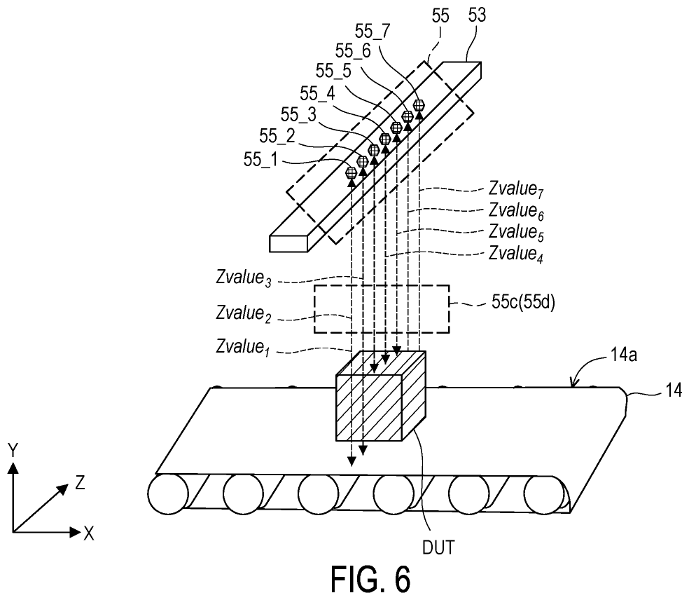

FIG. 6 is a schematic diagram illustrating calculation of the Z-axis value corresponding to each X-axis value according to an embodiment of the disclosure. Referring to FIG. 6, when the conveyor platform 14 is operating, the n feedback type sensors 55_1 to 55_n receive the reflected signal 55d reflected from the electromagnetic signal 55c to obtain the sensing feedback values Zvalue₁ to Zvalueₙ of each feedback type sensor 55_1 to 55_n. That is, the feedback type sensor 55_1 obtains the sensing feedback value Zvalue₁, the feedback type sensor 55_ₙ obtains the sensing feedback value Zvalueₙ, and so on.

Next, the processor 13 determines whether the sensing feedback values Zbase₁ to Zbaseₙ of each feedback type sensor 55_1 to 55_n are equal to the sensing reference values Zvalue₁ to Zvalueₙ. When the sensing feedback value Zbaseᵢ corresponding to a part of the feedback type sensors is not equal to the corresponding sensing reference value Zvalueᵢ, the processor 13 determines that the device under test DUT is passing through the sensing gate 11.

For example, as shown in FIG. 6, the electromagnetic signals 55c emitted by the feedback type sensors 55_1 to 55_2 and 55_6 to 55_7 contact the horizontal surface 14a of the conveyor platform 14 and form a reflected signal 55d to obtain the sensing feedback values Zvalue₁ to Zvalue₂, Zvalue₆ to Zvalue₇ of the feedback type sensors 55_1 to 55_2, 55_6 to 55_7. Wherein, the sensing feedback values Zvalue₁ to Zvalue₂ and Zvalue₆ to Zvalue₇ of the feedback type sensors 55_1 to 55_2 and 55_6 to 55_7 are equal to the sensing reference values Zbase₁ to Zbase₂ and Zbase₆ to Zbase₇.

The electromagnetic signal 55c emitted by the feedback type sensors 55_3 to 55_5 in the feedback type sensor 55 contacts the device under test DUT and forms a reflected signal 55d to obtain the sensing feedback values Zvalue₃ to Zvalue₅ of the feedback type sensors 55_3 to 55a_5, wherein the sensing feedback values Zvalue₃ to Zvalue₅ of the feedback type sensors 55a_3 to 55a_5 are not equal to the sensing reference values Zbase₃ to Zbase₅. The processor 13 may determine that the device under test DUT is passing through the sensing gate 11 based on the sensing feedback values Zvalue₃ to Zvalue₅ of the feedback type sensors 55_3 to 55_5 being different from the sensing reference values Zbase₃ to Zbase₅.

When the processor 13 determines that the device under test DUT is passing through the sensing gate 11, the processor 13 calculates the Z-axis value corresponding to each X-axis value according to formula (2):

$${Zvalue}_{i} = b \times {Z}_{r} , b = 1 ∼ n ; \qquad ( 2 )$$

Wherein, Zvalueᵢ is the Z-axis value corresponding to the X-axis value when the device under test DUT is located at the i^{th} position, b is the quantity of part of the feedback type sensors 55, Zᵣ is the second separation distance, and n is the total quantity of feedback type sensors 55.

As shown in FIG. 6, assuming that the device under test DUT is located at the second position, the electromagnetic signals 55c emitted by the feedback type sensors 55_3 to 55_5 of the feedback type sensors 55 contact the device under test DUT. Therefore, the Z-axis value sensed by the sensing gate 11 when the device under test DUT is located at the second position is Zvalue₂=2Zᵣ, 2Zᵣ is the width sensed by the sensing gate 11 when the device under test DUT is located at the second position.

Referring to FIG. 1 again, the volume measurement system 1 further includes the pedometer axle 15. The pedometer axle 15 is coupled to the pedometer 12 and the conveyor platform 14, and operates synchronously with the conveyor platform 14. When the device under test is placed on the conveyor platform 14 and driven by the conveyor platform 14, the pedometer axle 15 is configured to calculate the distance that the device under test moves in the physical space driven by the conveyor platform 14. The processor 13 may thereby record each X-axis value corresponding to each position of the device under test and calculate the Y-axis value and Z-axis value corresponding to each X-axis value.

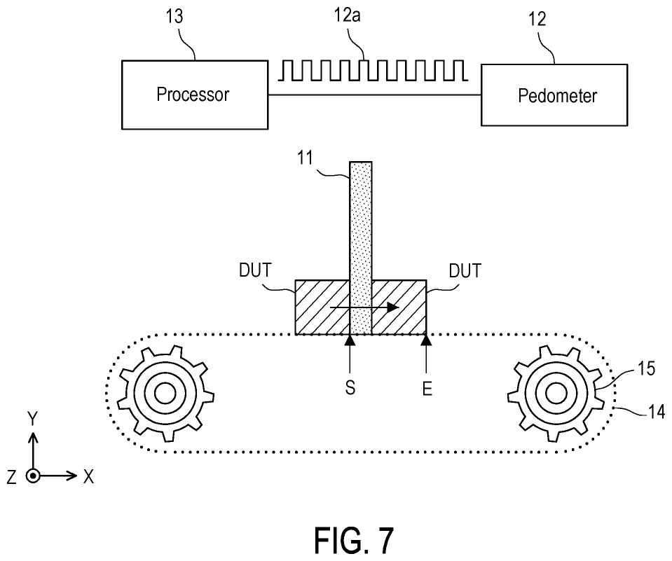

FIG. 7 is a schematic diagram illustrating the synchronous operation of the pedometer axle 15 and the conveyor platform 14 according to an embodiment of the disclosure. Referring to FIG. 7, when the pedometer axle 15 completes one rotation, the conveyor platform 14 drives the device under test DUT to move in the physical space for a unit distance value EM, and the quantity of pulse signals 12a generated by the pedometer 12 is the unit pulse number EC.

Before the device under test DUT starts to pass through the sensing gate 11, the processor 13 resets the accumulated pulse number Eᵢ counted in response to each pulse signal 12a to the initial pulse number E₀. Once the device under test DUT is located at the starting position S and begins to pass through the sensing gate 11 along the X-axis direction, the processor 13 receives the pulse signal 12a, counts the accumulated pulse number E; in response to each pulse signal 12a and records the X-axis value corresponding to each position of the device under test DUT. That is, the processor 13 receives a pulse signal 12a and synchronously records the X-axis value corresponding to the position of the device under test DUT in the physical space.

When the device under test DUT is located at the final position E, the accumulated pulse number Eᵢ is set to the total pulse number of 1. The final position E of the device under test DUT is the position at the moment when the device under test DUT completely passes through the sensing gate 11. The processor 13 calculates the X-axis value of the device under test at each position from the starting position S to the final position E according to formula (3):

$${X}_{i} = ( {E}_{i} - {E}_{0} ) \times ( \frac{EM}{EC} ) , i = 0 ∼ l \qquad ( 3 )$$

Wherein, Xᵢ is the X-axis value of the device under test DUT recorded in response to the i^{th} pulse signal 12a, E₀ is the initial pulse number, Eᵢ is the accumulated pulse number counted in response to the i^{th} pulse signal 12a, EM is the unit distance value, EC is the unit pulse number, and l is the total pulse number.

When the device under test DUT finishes passing through the sensing gate 11 and is located at the final position E, in response to the final pulse signal among multiple pulse signals 12a, the processor 13 records the maximum X-axis value corresponding to the final position E of the device under test DUT. In other words, during the period from when the device under test DUT starts passing through the sensing gate 11 to when it finishes passing through the sensing gate 11, the maximum X-axis value recorded among the X-axis values by the processor 13 is the maximum length of the device under test DUT.

Then, the processor 13 searches for the largest one among the multiple Y-axis values corresponding to all the X-axis values, and sets the largest one among the multiple Y-axis values corresponding to the multiple X-axis values as the maximum Y-axis value. This maximum Y-axis value is the maximum height of the device under test DUT. The processor 13 also searches for the largest one among the multiple Z-axis values corresponding to all the X-axis values, and sets the largest one among the multiple Z-axis values corresponding to the multiple X-axis values as the maximum Z-axis value. This maximum Z-axis value is the maximum width of the device under test DUT.

Once the processor 13 receives the maximum X-axis value, the maximum Y-axis value and the maximum Z-axis value in the sensing data obtained by the sensing gate 11, the volume of the device under test DUT is calculated based on the maximum X-axis value, maximum Y-axis value and maximum Z-axis value.

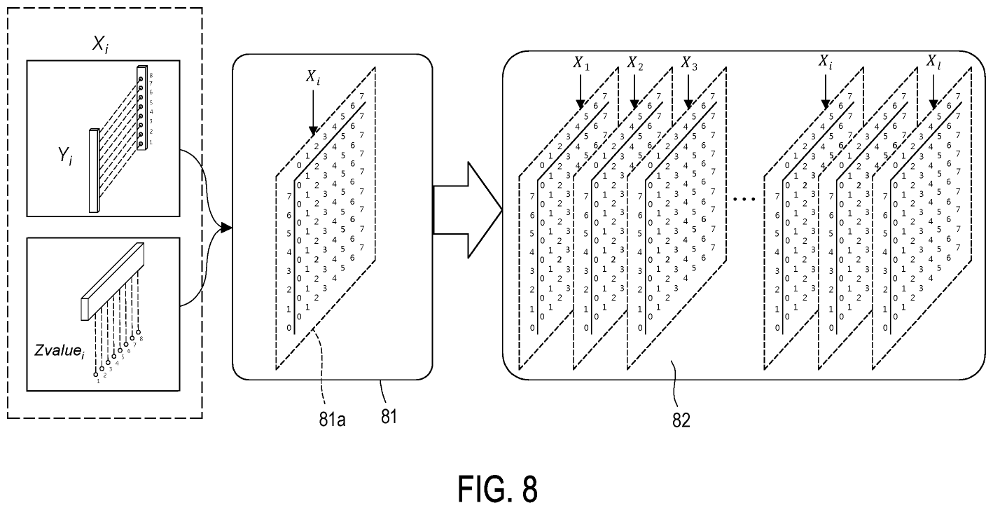

FIG. 8 is a schematic diagram of establishing two-dimensional point cloud data 81a and point cloud diagram 82 in a volume measurement system according to an embodiment of the disclosure. In one embodiment, during the process of the device under test DUT passing through the sensing gate 11, in addition to recording each X-axis value Xᵢ corresponding to each position and calculating the Y-axis value Yᵢ and Z-axis value Zvalueᵢ corresponding to each X-axis value Xᵢ, the processor 13 further establishes two-dimensional point cloud data 81a related to each X-axis value Xᵢ according to the Y-axis value Yᵢ and Z-axis value Zvalueᵢ corresponding to each X-axis value Xᵢ. Specifically, during the process of the device under test DUT passing through the sensing gate 11, the device under test DUT has a cloud section 81 for each X-axis value Xᵢ corresponding to each position. The cloud section 81 is orthogonal to the X-axis. Therefore, the cloud section 81 includes the Y-axis value Yᵢ and the Z-axis value Zvalueᵢ corresponding to the X-axis value Xᵢ, that is, the two-dimensional point cloud data 81a corresponding to the X-axis value.

After the processor 13 establishes the two-dimensional point cloud data 81a related to each X-axis value Xᵢ, the processor 13 may further establish a point cloud diagram 82 related to the device under test DUT according to the multiple two-dimensional point cloud data 81a corresponding to all X-axis values Xᵢ. In other words, the point cloud graph 82 includes the Y-axis value Yᵢ and the Z-axis value Zvalueᵢ corresponding to each of all X-axis values Xᵢ.

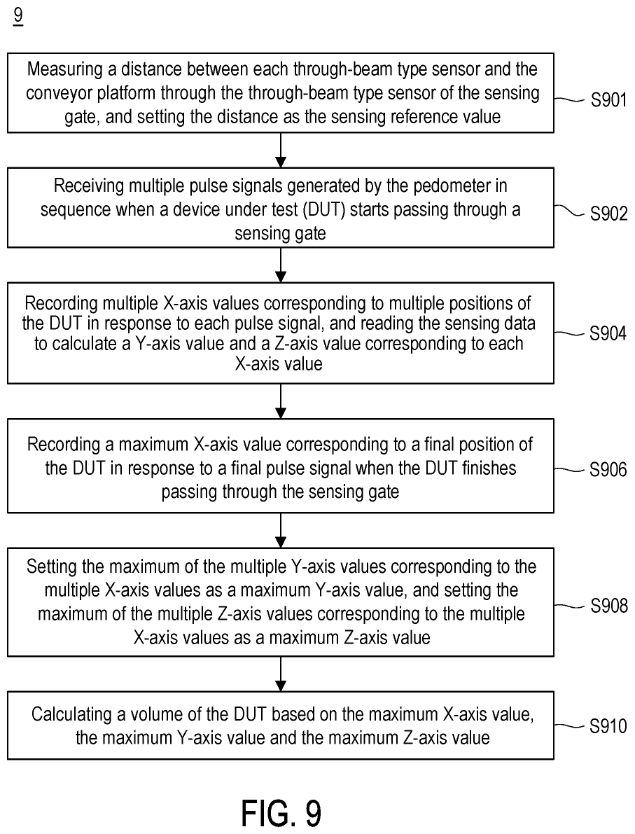

FIG. 9 is a flowchart of a volume measurement method 9 according to an embodiment of the disclosure. Referring to FIG. 1, FIG. 4, FIG. 6, FIG. 7 and FIG. 9 at the same time, for the process of the volume measurement method 9 in FIG. 9, reference may be made to the volume measurement system 1 in FIG. 1. While the sensing gate 11 in the volume measurement system 1 senses the device under test and obtains sensing data, the processor 13 measures the volume of the device under test through the process of the volume measurement method 9. The process of volume measurement method 9 includes steps S901, S902, S904, S906, S908 and S910.

In step S902, when the device under test DUT starts passing through the sensing gate 11, multiple pulse signals 12a generated by the pedometer 12 are received.

In step S904, in response to each pulse signal 12a, multiple X-axis values corresponding to multiple positions of the device under test DUT are recorded, and the sensing data is read to calculate the Y-axis value and Z-axis value corresponding to each X-axis value, in which the sensing data is obtained by sensing the device under test DUT through the sensing gate 14. Details about recording the X-axis value corresponding to each position of the device under test DUT and reading the sensing data to calculate the Y-axis value and Z-axis value corresponding to each X-axis value have been explained in the previous paragraphs, and are not repeated herein.

In step S906, when the device under test DUT finishes passing through the sensing gate 14, in response to the final pulse signal among multiple pulse signals 12a, the maximum X-axis value corresponding to the final position of the device under test DUT is recorded, and the maximum X-axis value is the maximum length of the device under test DUT. Details about recording the maximum X-axis value corresponding to the final position E of the device under test DUT in response to the final pulse signal among multiple pulse signals 12a have been explained in the previous paragraphs, and are not repeated herein.

In step S908, the largest one among the multiple Y-axis values corresponding to the multiple X-axis values is set as the maximum Y-axis value, and the largest one among the multiple Z-axis values corresponding to the multiple X-axis values is set as the maximum Z-axis value. The maximum Y-axis value is the maximum height of the device under test DUT, and the maximum Z-axis value is the maximum width of the device under test DUT. Details about setting the largest one among the multiple Y-axis values corresponding to the multiple X-axis values as the maximum Y-axis value, and setting the largest one among the multiple Z-axis values corresponding to the multiple X-axis values as the maximum Z-axis value have been explained in the previous paragraphs, and are not repeated herein.

In step S910, the volume of the device under test DUT is calculated based on the maximum X-axis value, the maximum Y-axis value, and the maximum Z-axis value.

Before measuring the volume of the device under test DUT, the distance between the through-beam type sensors 53a_1 to 53a_n and the conveyor platform 14 is measured through the through-beam type sensors 53a_1 to 53a_n of the sensing gate 14. This distance is set as the sensing reference value Zbase₁ to Zbaseₙ, whether a device under test DUT is passing through the sensing gate 14 is determined by using the sensing reference values Zbase₁ to Zbaseₙ. Therefore, before step S902 of the volume measurement method 9, step S901 is also included.

In step S901 before step S902, when the conveyor platform 14 is stationary, the sensing reference values Zbase₁ to Zbaseₙ of the feedback type sensors 53a_1 to 53a_n are obtained by emitting electromagnetic signals from the feedback type sensors 53a_1 to 53a_n of the sensing gate 11 and receiving the reflected signal 55d of the electromagnetic signal 55c reflected by the conveyor platform 11.

Once the sensing reference values Zbase₁ to Zbaseₙ of the feedback type sensors 53a_1 to 53a_n are obtained, in step S802, it may be determined that the device under test DUT is passing through the sensing gate 11 through the sensing reference values Zbase₁ to Zbaseₙ.

To sum up, in the volume measurement system and the volume measurement method provided by the disclosure, through the concept of determining that there is an object at the sensing position when the sensing signal is blocked, on one hand, a feedback type sensor with a ranging function is disposed in the Z-axis direction to sense whether there is a feedback signal from the object, thereby obtaining the height value of the object. On the other hand, a through-beam type sensor is disposed in the Y-axis direction to sense whether the information is shielded by the object, thereby obtaining the width value of the object. Furthermore, the volume of an object may be calculated by determining the maximum length of the object through a pedometer, and by searching for the maximum height value and maximum width value of the object from the height value and width value of the object at each position. Therefore, the volume measurement system and the volume measurement method provided by the disclosure may overcome common issues in the volume measurement system and the method the same thereof using TOF technology, which are often affected by metals and reflective objects. It takes into account both the high efficiency of automated conveyance and the high precision of volume measurement of goods.

What is claimed is:

1. A volume measurement system, comprising:
a sensing gate, configured to sense a device under test to obtain a plurality of sensing data;
a pedometer, configured to generate a plurality of pulse signals; and
a processor, coupled to the sensing gate and the pedometer, and configured to:
receive the pulse signals when the device under test starts passing through the sensing gate;
record a plurality of X-axis values corresponding to a plurality of positions of the device under test in response to each of the pulse signals, and read the sensing data to calculate a Y-axis value and a Z-axis value corresponding to each of the X-axis values;
record a maximum X-axis value corresponding to a final position of the device under test in response to a final pulse signal among the pulse signals when the device under test finishes passing through the sensing gate;
set a maximum of the Y-axis values corresponding to the X-axis values as a maximum Y-axis value, and set a maximum of the Z-axis values corresponding to the X-axis values as a maximum Z-axis value; and
calculate a volume of the device under test based on the maximum X-axis value, the maximum Y-axis value and the maximum Z-axis value.

2. The volume measurement system according to claim 1, wherein the sensing gate comprises:
a first side bracket and a second side bracket, spaced apart parallel to a Z-axis and parallel to each other;
an upper bracket, parallel to the Y-axis, spanning across top ends of the first side bracket and the second side bracket;
a plurality sets of through-beam type sensors, comprising:
a plurality of transmitters, arranged on the first side bracket for transmitting a plurality of through-beam type sensing signals, wherein each of the transmitters is separated by a first separation distance; and
a plurality of receivers, arranged on the second side bracket and aligned in sequence with each of the transmitters for receiving each of the through-beam type sensing signals transmitted by each of the transmitters, wherein each of the receivers is separated by the first separation distance; and
a plurality of feedback type sensors, arranged on the upper bracket for emitting a plurality of electromagnetic signals and receiving reflected signal of each of the electromagnetic signals, wherein each of the feedback type sensors is separated by a second separation distance.

3. The volume measurement system according to claim 2, further comprising:
a conveyor platform, disposed between the first side bracket and the second side bracket to drive the device under test to pass through the sensing gate parallel to an X-axis.

4. The volume measurement system according to claim 3, wherein when the device under test is passing through the sensing gate, part of the through-beam type sensing signals is blocked by the device under test, the processor is further configured to:
determining part of the through-beam type sensing signals and calculating corresponding quantity of part of the through-beam type sensors when the device under test is located at each of the positions; and
calculating the Y-axis value when the device under test is located at each of the positions according to the quantity of part of the through-beam type sensors.

5. The volume measurement system according to claim 4, wherein the transmitters comprises:
a first transmitter, disposed on the first side bracket and located at a first height above a horizontal plane of the conveyor platform; and
remaining transmitters, arranged vertically in an ascending sequence on the first side bracket, starting from a position vertically above a first separation distance from the first transmitter, in a direction away from the horizontal plane of the conveyor platform;
wherein the processor calculates the Y-axis value corresponding to each of the X-axis values when the device under test is passing through the sensing gate and is located at each of the positions:
$${Y}_{i} = {Y}_{1} + ( a - 1 ) \times {Y}_{r} , a = 1 ∼ m ;$$
wherein, Yᵢ is the Y-axis value corresponding to the X-axis value when the device under test is located at an i^{th} position, Y₁ is the first height, a is quantity of part of the through-beam type sensors blocked by the device under test, Yᵣ is the first separation distance, and m is total quantity of the transmitters.

6. The volume measurement system according to claim 3, wherein the feedback type sensors of the sensing gate are further configured to emit the electromagnetic signals and receive the reflected signals of the electromagnetic signals reflected via the conveyor platform to obtain a sensing reference value of each of the feedback type sensors when the conveyor platform is stationary.

7. The volume measurement system according to claim 6, wherein the feedback type sensors receive the reflected signals of the electromagnetic signals to obtain sensing feedback value of each of the feedback sensors when the conveyor platform is operating.

8. The volume measurement system according to claim 7, wherein the processor is further configured to:
determining whether the sensing feedback value of each of the feedback type sensors is equal to the sensing reference value when the conveyor platform is operating;
determining that the device under test is passing through the sensing gate when the sensing feedback value corresponding to part of the feedback type sensors is not equal to the corresponding sensing reference value; and
calculating the Z-axis value when the device under test is located at each of the positions according to quantity of part of the feedback type sensors.

9. The volume measurement system according to claim 8, wherein the processor calculates the Z-axis value corresponding to each of the X-axis values when the processor determines that the device under test is passing through the sensing gate:
$${Zvalue}_{i} = b \times {Z}_{r} , b = 1 ∼ n ;$$
wherein, Zvalueᵢ is the Z-axis value corresponding to the X-axis value when the device under test is located at an i^{th} position, b is quantity of part of the feedback type sensors, Zᵣ is the second separation distance, and n is total quantity of the feedback type sensors.

10. The volume measurement system according to claim 3, further comprising:
a pedometer axle, coupled to the pedometer and the conveyor platform, configured to operate synchronously with the conveyor platform, the conveyor platform drives the device under test for a distance of one unit distance value when the pedometer axle completes one rotation, and a quantity of the pulse signals generated by the pedometer is a unit pulse number;
wherein the processor is further configured to:
reset an accumulated pulse number counted in response to each of the pulse signals to an initial pulse number;
receive the pulse signals when the device under test is passing through the sensing gate, count the accumulated pulse number in response to each of the pulse signals and record the X-axis value corresponding to each of the positions of the device under test; and
set the accumulated pulse number as a total pulse number when the device under test is located at the final position;
wherein the X-axis value of the device under test at each of the positions is:
$${X}_{i} = ( {E}_{i} - {E}_{0} ) \times ( \frac{EM}{EC} ) , i = 0 ∼ l ;$$
wherein, Xᵢ is the X-axis value of the device under test recorded in response to an i^{th} pulse signal, E₀ is the initial pulse number, E; is the accumulated pulse number counted in response to i^{th} pulse signal, EM is the unit distance value, EC is the unit pulse number, and l is the total pulse number.

11. The volume measurement system according to claim 1, wherein the processor further establishes two-dimensional point cloud data related to each of the X-axis values according to the Y-axis value and Z-axis value corresponding to each of the X-axis values, and establish a point cloud diagram related to the device under test according to a plurality of the two-dimensional point cloud data corresponding to the X-axis values.

12. A volume measurement method, comprising:
receiving a plurality of pulse signals generated by a pedometer when a device under test starts passing through a sensing gate;
recording a plurality of X-axis values corresponding to a plurality of positions of the device under test in response to each of the pulse signals, and reading a plurality of sensing data to calculate a Y-axis value and a Z-axis value corresponding to each of the X-axis values, wherein the sensing data is obtained by sensing the device under test through the sensing gate;
recording a maximum X-axis value corresponding to a final position of the device under test in response to a final pulse signal among the pulse signals when the device under test finishes passing through the sensing gate;
setting a maximum of the Y-axis values corresponding to the X-axis values as a maximum Y-axis value, and setting a maximum of the Z-axis values corresponding to the X-axis values as a maximum Z-axis value; and
calculating a volume of the device under test based on the maximum X-axis value, the maximum Y-axis value and the maximum Z-axis value.

13. The volume measurement method according to claim 12, wherein the sensing gate comprises a plurality sets of through-beam type sensors and a plurality of feedback type sensors, the volume measurement method further comprises:
emitting a plurality of through-beam type sensing signals parallel to a Y-axis through a plurality of transmitters of the through-beam type sensors, and receiving each of the through-beam type sensing signals emitted by each of the transmitters through a plurality of receivers of the through-beam type sensors, wherein each of the transmitters are aligned with each of the receivers; and
emitting a plurality of electromagnetic signals parallel to a Z-axis and receiving reflected signals of each of the electromagnetic signals through the feedback type sensors.

14. The volume measurement method according to claim 13, further comprising:
driving the device under test to pass through the sensing gate through a conveyor platform parallel to an X-axis.

15. The volume measurement method according to claim 14, wherein when the device under test is passing through the sensing gate, part of the through-beam type sensing signals is blocked by the device under test, the volume measurement method further comprises:
determining part of the through-beam type sensing signals and calculating corresponding quantity of part of the through-beam type sensors when the device under test is located at each of the positions; and
calculating the Y-axis value when the device under test is located at each of the positions according to the quantity of part of the through-beam type sensors.

16. The volume measurement method according to claim 15, further comprising:
calculating the Y-axis value corresponding to each of the X-axis values when the device under test is passing through the sensing gate and is located at each of the positions:
$${Y}_{i} = {Y}_{1} + ( a - 1 ) \times {Y}_{r} , a = 1 ∼ m ;$$
wherein, Yᵢ is the Y-axis value corresponding to the X-axis value when the device under test is located at an i^{th} position, Y₁ is a first height, a is quantity of part of the through-beam type sensors blocked by the device under test, Yᵣ is the first separation distance, and m is total quantity of the transmitters;
wherein the first height is a minimum height of the transmitters from a horizontal plane of the conveyor platform.

17. The volume measurement method according to claim 14, further comprising:
emitting the electromagnetic signals and receiving the reflected signals of the electromagnetic signals reflected via the conveyor platform through the feedback type sensors of the sensing gate to obtain the sensing reference value of each of the feedback type sensors when the conveyor platform is stationary.

18. The volume measurement method according to claim 17, further comprising:
receiving the reflected signals of the electromagnetic signals to obtain a sensing feedback value of each of the feedback sensors through the feedback type sensors of the sensing gate when the conveyor platform is operating.

19. The volume measurement method according to claim 18, further comprising:
determining whether the sensing feedback value of each of the feedback type sensors is equal to the sensing reference value when the conveyor platform is operating;
determining that the device under test is passing through the sensing gate when the sensing feedback value corresponding to part of the feedback type sensors is not equal to the corresponding sensing reference value; and
calculating the Z-axis value when the device under test is located at each of the positions according to quantity of part of the feedback type sensors.

20. The volume measurement method according to claim 19, further comprising:
calculating the Z-axis value corresponding to each of the X-axis values when it is determined that the device under test is passing through the sensing gate,
$${Zvalue}_{i} = b \times {Z}_{r} , b = 1 ∼ n ;$$
wherein, Zvalueᵢ is the Z-axis value corresponding to the X-axis value when the device under test is located at an i^{th} position, b is quantity of part of the feedback type sensors, Zᵣ is a distance of each of the feedback type sensors, and n is total quantity of the feedback type sensors.

21. The volume measurement method according to claim 14, wherein the conveyor platform operates synchronously with a pedometer axle, the conveyor platform drives the device under test for a distance of one unit distance value when the pedometer axle completes one rotation, and a quantity of the pulse signals generated by the pedometer is a unit pulse number, the volume measurement method further comprises;
resetting an accumulated pulse number counted in response to each of the pulse signals to an initial pulse number;
receiving the pulse signals when the device under test is passing through the sensing gate, counting the accumulated pulse number in response to each of the pulse signals and recording the X-axis value corresponding to each of the positions of the device under test; and
setting the accumulated pulse number as a total pulse number when the device under test is located at the final position;
wherein the X-axis value of the device under test at each of the positions is:
$${X}_{i} = ( {E}_{i} - {E}_{0} ) \times ( \frac{EM}{EC} ) , i = 0 ∼ l ;$$
wherein, Xᵢ is the X-axis value when the device under test is located at an i^{th} position, E₀ is the initial pulse number, E; is the accumulated pulse number counted in response to i^{th} pulse signal, EM is the unit distance value, EC is the unit pulse number, and l is the total pulse number.

22. The volume measurement method according to claim 12, further comprising:
establishing two-dimensional point cloud data related to each of the X-axis values according to the Y-axis value and Z-axis value corresponding to each of the X-axis values, and
establishing a point cloud diagram related to the device under test according to a plurality of the two-dimensional point cloud data corresponding to the X-axis values.

23. A volume measurement system, comprising:
a sensing gate, configured to sense a device under test to obtain a plurality of sensing data, wherein the sensing gate comprises:
a first side bracket and a second side bracket, spaced apart parallel to a Z-axis and parallel to each other;
an upper bracket, parallel to the Y-axis, spanning across top ends of the first side bracket and the second side bracket;
a plurality sets of through-beam type sensors, comprising:
a plurality of transmitters, arranged on the first side bracket for transmitting a plurality of through-beam type sensing signals, wherein each of the transmitters is separated by a first separation distance; and
a plurality of receivers, arranged on the second side bracket and aligned in sequence with each of the transmitters for receiving each of the through-beam type sensing signals transmitted by each of the transmitters, wherein each of the receivers is separated by the first separation distance; and
a plurality of feedback type sensors, arranged on the upper bracket for emitting a plurality of electromagnetic signals and receiving reflected signal of each of the electromagnetic signals, wherein each of the feedback type sensors is separated by a second separation distance;
a pedometer, configured to generate a plurality of pulse signals; and
a processor, coupled to the sensing gate and the pedometer, and configured to receive the pulse signals when the device under test starts passing through the sensing gate.

24. The volume measurement system according to claim 23, wherein
the sensing gate and the pedometer record a plurality of X-axis values corresponding to a plurality of positions of the device under test in response to each of the pulse signals, and read the sensing data to calculate a Y-axis value and a Z-axis value corresponding to each of the X-axis values;
record a maximum X-axis value corresponding to a final position of the device under test in response to a final pulse signal among the pulse signals when the device under test finishes passing through the sensing gate;
set a maximum of the Y-axis values corresponding to the X-axis values as a maximum Y-axis value, and set a maximum of the Z-axis values corresponding to the X-axis values as a maximum Z-axis value; and
calculate a volume of the device under test based on the maximum X-axis value, the maximum Y-axis value and the maximum Z-axis value.
